(19) United States
(12) Patent Application Publication
(10) Pub. No.: US 2013/0010243 A1
(43) Pub. Date: Jan. 10, 2013

(54) MANUFACTURING METHOD OF ROLLER FOR PHASE RETARDATION FILM, METHOD FOR MANUFACTURING PHASE RETARDATION FILM BY ROLLER AND PHASE RETARDATION FILM THEREFORM

(75) Inventors: Fung-Hsu WU, Taoyuan County (TW); Lung-Hai WU, Taoyuan County (TW)

(73) Assignee: BENQ MATERIALS CORPORATION, Taoyuan County (TW)

(21) Appl. No.: 13/483,013

(22) Filed: May 29, 2012

(30) Foreign Application Priority Data
Jul. 7, 2011 (TW) 100124104

(51) Int. Cl. G02F 1/1335; B05D 5/06; B24B 1/00

(52) U.S. Cl. 349/117; 451/49; 427/162

(57) ABSTRACT

A phase retardation film, a manufacturing method thereof and a manufacturing method of a roller used in the manufacturing method are provided. The phase retardation film includes a base film, a patterned resin layer and a phase retardation layer. The patterned resin layer having a plurality of first regions and a plurality of second regions is formed on the base film. The patterned resin layer includes a submicro-scratch structure. The angle between the direction of the submicro-scratch structure and the extending direction of the first and second regions is 45°. A liquid crystal material is disposed on the submicro-scratch structure of the patterned resin layer to form the phase retardation layer. The phase difference between a first phase retardation and a second phase retardation is 180°.

### RELATED APPLICATIONS

This application claims priority to Taiwan Application Serial Number 100124104, filed Jul. 7, 2011, which is herein incorporated by reference.

### BACKGROUND OF THE INVENTION

1. Field of the Invention

The invention relates in general to a phase retardation film, to a method for manufacturing the same, to a manufacturing method of roller for the phase retardation film, and more particularly to a phase retardation film with at least two phase retardations, to a manufacturing method thereof, and to a manufacturing method of roller for the phase retardation film.

2. Description of the Related Art

It is known that applying a phase retardation film to applications of three-dimensional technology such as three-dimensional stereo displays and glasses, a stereoscopic image is generated by passing through the phase retardation film with different phase retardations.

A submicro-scratch structure of the phase retardation film whereon dispose a liquid crystal material forms an alignment; the liquid crystal material on different regions of different thickness of the phase retardation film forms different phase retardation thereon.

The submicro-scratch structure of the phase retardation film is the key factor for influencing optical performance, and it should be manufactured with quite a high precision to ensure the optical quality. However, the manufacturing speed of the phase retardation film cannot improve efficiently under the high precision; thereby it needs a tool for manufacturing the phase retardation film rapidly and precisely to meet the industrial demand.

### SUMMARY OF THE INVENTION

The present invention is to provide a phase retardation film, a method for manufacturing the same, and a method of making a roller for manufacturing the phase retardation film. The steps of the method of making the roller include engraving a surface of roller with an engraving means, and rubbing the surface with a rubbing pad to form particular engraved or grooved structures thereon. The roller with the particular structures on the surface can emboss a base film for using in the manufacture of a phase retardation film with different phase retardations rapidly and precisely for the applications of three-dimensional display technology.

According to an aspect of the present invention, a method for making a roller used in manufacturing a phase retardation film is provided. The method comprises the following steps of providing a roller, which has a rotating shaft and a surface; providing an engraving means, which has a engraving end; engraving a surface of the roller with the engraving means along a rotating direction of the roller with a depth to form a grooved structure on the surface of the roller; providing a rubbing pad with a rubbing surface; and rubbing the grooved surface of the roller with the rubbing surface of the rubbing pad to form a submicro-scratch structure thereon, wherein the extending direction of the submicro-scratch structure is in an angle of 45° to the rotating direction of the roller.

According to a further aspect of the present invention, a method for manufacturing a phase retardation film including a phase retardation layer with a plurality of first phase retardation regions and a plurality of second phase retardation regions is provided. The phase difference between the first phase retardation regions and the second phase retardation regions is 180°.

The method for manufacturing a phase retardation film comprising the steps of providing a base film; coating a curable resin layer on a surface of the base film; embossing the curable resin layer with the roller made by the method as mentioned above to form a patterned resin layer with a plurality of first regions and a plurality of second regions, wherein the structures of first regions and second regions are grating stripe structures and are parallel to and interleaved with each other, and embossing the curable resin layer with the roller made by the aforementioned method to form a submicro-scratch structure for alignment on the bottom surface of the first regions and the top surface of the second regions at the same time, wherein the submicro-scratch structure includes a plurality of grooving stripes, and the angle between an extending direction of the grooving stripes of the submicro-scratch structure for alignment and an extending direction of the grating stripe structures of the first regions and the second regions is substantially 45°; curing the patterned resin layer; and disposing a liquid crystal material on the submicro-scratch structure of the patterned resin layer to form the phase retardation layer, wherein the liquid crystal material over the first regions provides the first phase retardation regions and the liquid crystal material over the second regions provides the second phase retardation regions.

In another aspect of the present invention, a phase retardation film is provided. The phase retardation film comprises a base film; a patterned resin layer with a plurality of first regions and a plurality of second regions on the base film, wherein the structures of the first and second regions are grating stripe structures and parallel to each other and the structure of first regions relative to that of second regions are grating-like relief structures and interleaved with each other. The patterned resin layer comprises a submicro-scratch structure for alignment on the bottom surface of the first regions and the top surface of the second regions of the patterned resin layer, wherein the submicro-scratch structure includes a plurality of submicro-grooving stripes, and the angle between the direction of the submicro-scratch structure and the extending direction of the plurality of first and second regions is substantially 45°; and a phase retardation layer forming by disposing a liquid crystal material on the submicro-scratch structure of the patterned resin layer, wherein the liquid crystal material over the first regions provides a first phase retardation and the liquid crystal material over the second regions provides a second phase retardation, and the phase difference between the first phase retardation and the second phase retardation is 180°.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a cross-sectional view of a phase retardation film of an embodiment of the present invention;

FIG. 2 shows a stereo diagrammatic view of a patterned resin layer in FIG. 1;

FIG. 3 is a flow chart of a method for manufacturing a phase retardation film of an embodiment of the present invention;

FIGS. 4A to 4E illustrate the steps of the method for manufacturing the phase retardation film in FIG. 3;

FIG. 5 is a flow chart of a manufacturing method of a roller for the phase retardation film of an embodiment of the present invention; and

FIGS. 6A to 6D illustrate the steps of the manufacturing method of a roller for the phase retardation film in FIG. 5.

### DETAILED DESCRIPTION OF THE INVENTION

Please note the drawings shown in the Figures are for illustrative purposes only and not to scale.

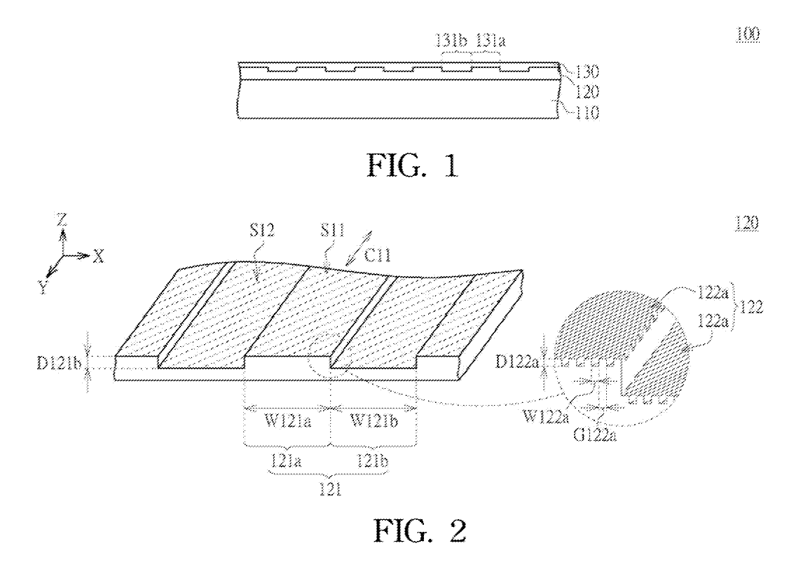

A phase retardation film 100 manufactured by the method of an embodiment of the present invention is shown in FIG. 1. The phase retardation film 100 comprises a base film 110, a patterned resin layer 120 and a phase retardation layer 130. The base film 110 is a transparent and flexible substrate made from poly(ethylene terephthalate) (PET), polycarbonate (PC), triacetyl cellulose (TAC), poly(methyl methacrylate) (PMMA) or cyclo-olefin polymer (COP). The thickness of the base film 110 is in the range of 30 micron to 300 micron. The patterned resin layer 120 is formed on the base film 110. The patterned resin layer 120 is a transparent resin. The phase retardation layer 130 is disposed above the patterned resin layer 120. The phase retardation layer 130 can include a liquid crystal material. In the embodiment of the present invention, the liquid crystal material includes a Vertical Alignment liquid crystal material and contacts with the patterned resin layer directly and aligned with the submicro-scratch structure thereof; and the phase retardation layer 130 is cured and has the fixed alignment liquid crystal material therein. Light can generate phase retardation effect by passing the phase retardation layer 130.

FIG. 2 shows a stereo diagrammatic view of a patterned resin layer 120 in FIG. 1. The patterned resin layer 120 includes a plurality of first regions 121a and a plurality of second regions 121b. The first regions 121a and the second regions 121b are grating stripe structures 121 and parallel to each other, and the respective first regions 121a relative to the respective structures of second regions 121b form grating relief structures and extended along the Y axis and interleaved with each other.

Each width W121a of the first regions 121a is equal to each width W121b of the second regions 121b. The width W121a of the first regions 121a and the width W121b of the second regions 121b are for example in the range of 250 micron to 7,00 micron. Each depth D121b of the second regions 121b is for example in the range of 0.1 micron to 3.0 micron.

The patterned resin layer 120 shown in FIG. 2 comprises a submicro-scratch structure 122 for alignment on the top surface S11 of the first regions 121a and the bottom surface S12 of the second regions 121b of the patterned resin layer. The submicro-scratch structure 122 includes a plurality of grooving stripes 122a, and the angle between the direction of the submicro-scratch structure and the extending direction C11 (Y axis) of the first and second regions is substantially 45°. In other words, the grooving stripes 122a are substantially parallel to each other and intersect the extending direction C11 in an angle; thus a liquid crystal material disposed over the grooving stripes 122a has a same alignment direction with the direction of the grooving stripes 122a.

As shown in FIG. 2, each depth D122a of the grooving stripes 122a is substantially the same, and the width W122a of the grooving stripes 122a is substantially the same, and each interval G122a between any two of the adjacent grooving stripes 122a is substantially the same. Thereby the alignment force between the grooving stripes 122a and the liquid crystal material is substantially the same.

The phase retardation layer 130 shown in FIG. 1 contacts with the patterned resin layer directly and aligned with the submicro-scratch structure 122 shown in FIG. 2. The phase retardation layer 130 includes a plurality of first phase retardation regions 131a corresponded to the first regions 121a and a plurality of second phase retardation regions 131b corresponded to the second regions 121b. When light pass through the phase retardation film 100, the first phase retardation regions 131a in the phase retardation layer 130 provides a first phase retardation and the second phase retardation regions 131b in the phase retardation layer 130 provides a second phase retardation. The phase difference between the first phase retardation and the second phase retardation is 180°. Thus the phase retardation generated from the phase retardation film 100 can apply to stereoscopic display technology.

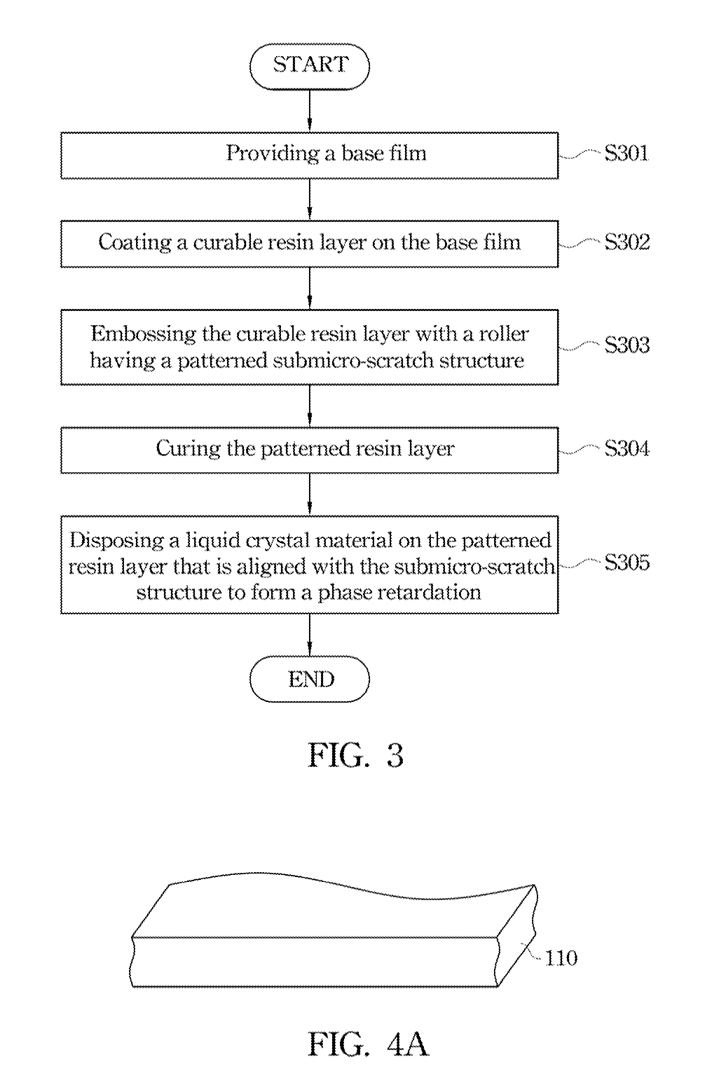

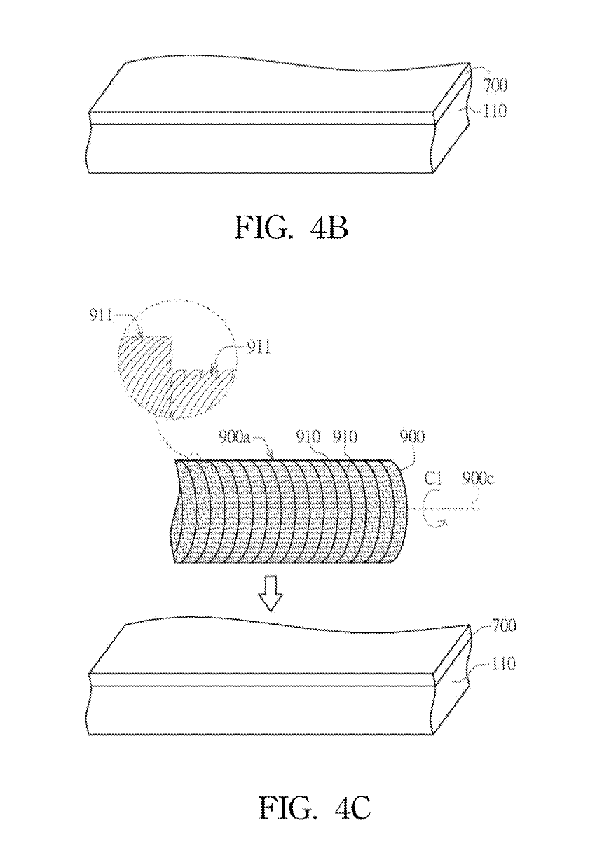

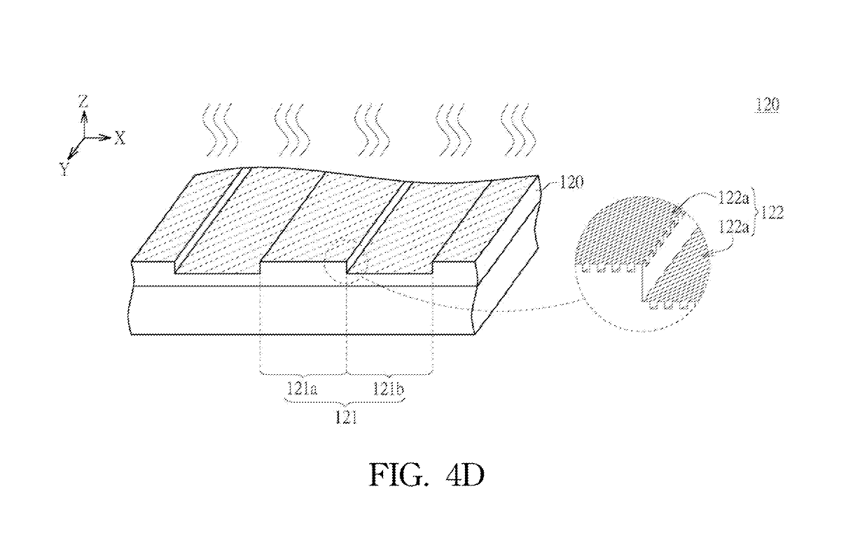

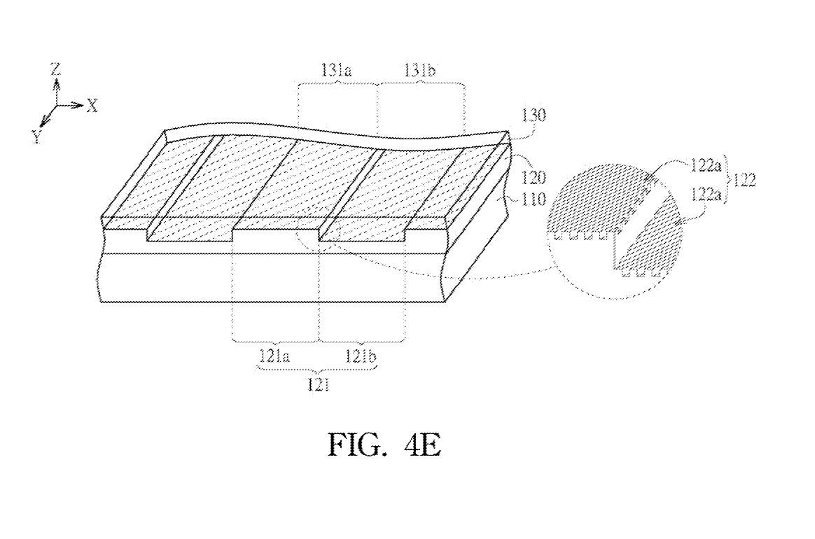

Referring to FIG. 3 and FIG. 4A to 4E, FIG. 3 is a flow chart of a method for manufacturing a phase retardation film 100 of an embodiment of the present invention; FIGS. 4A to 4E illustrate the steps of the method for manufacturing the phase retardation film in FIG. 3. In step S301, as shown in FIG. 4A, a base film 110 is provided.

In step S302, as shown in FIG. 4B, a curable resin layer 700 is coated on the base film. The curable resin layer 700 is flexible and can be extruded and deformed at room temperature, but the deformation of the curable resin layer 700 is irreversible even if the extruding force is removed.

In step S303, as shown in FIG. 4C, a patterned resin layer 120 is formed by embossing the curable resin layer 700 with a roller 900. The roller 900 has a rotating shaft 900c and a surface 900a with a grooved structure 910 along the rotating direction C1 of the roller. A submicro-scratch structure 911 is formed on the surface of the grooved structure 910. The extending direction of the submicro-scratch structure 911 is substantially in an angle of 45° to the rotating direction C1 of the roller 900.

As shown in FIG. 4D, the patterned resin layer 120 embossed by the roller 900 with the grooved structure 910 includes a plurality of first regions 121a and a plurality of second regions 121b, wherein the structures of first regions 121a and second regions 121b are grating stripe structures 121 and parallel to and interleaved with each other and to form a submicro-scratch structure 122 for alignment embossed by the submicro-scratch structure 911 of the roller 900 on the top surface S11 of the first regions 121a and the bottom surface S12 of the second regions 121b at the same time. The submicro-scratch structure 122 includes a plurality of grooving stripes 122a, and the angle between a direction of the grooving stripes 122a of the submicro-scratch structure 122 and an extending direction C11 of the grating stripe structures 121 of the first regions and the second regions is substantially 45°.

In step S304, as shown in FIG. 4D, the patterned resin layer is cured.

In step S305, as shown in FIG. 4E, a phase retardation layer 130 is formed by disposing a liquid crystal material on the submicro-scratch structure 122 of the patterned resin layer 120, wherein the liquid crystal material directly contacts with the patterned resin layer 120, and the liquid crystal material over the first regions 121a provides a first phase retardation 131a and the liquid crystal material over the second regions 121b provides a second phase retardation 131b, and the phase difference between the first phase retardation 131a and the second phase retardation 131b is 180°.

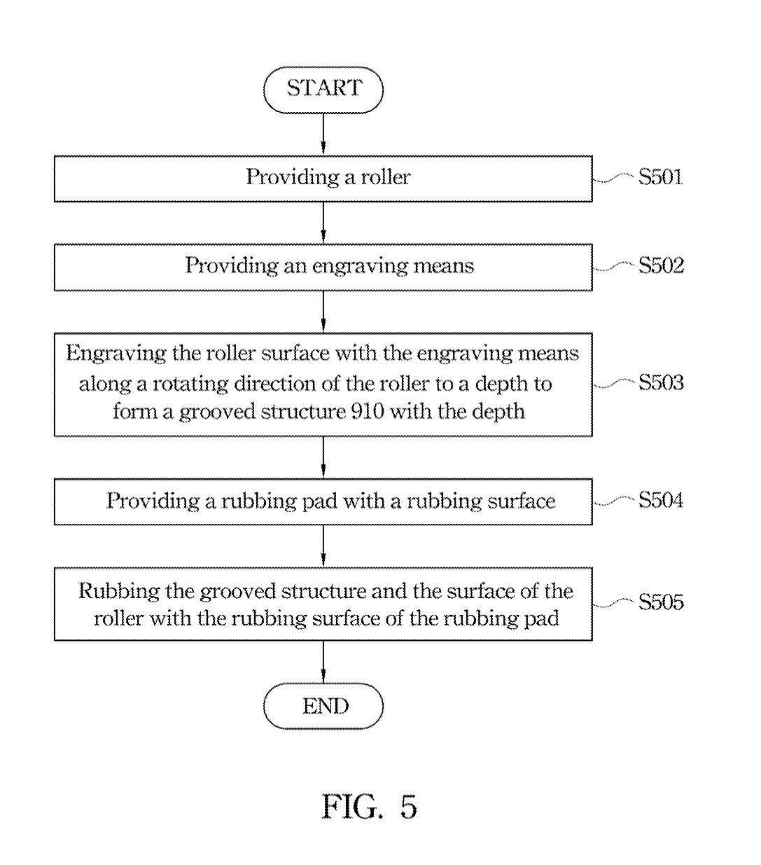

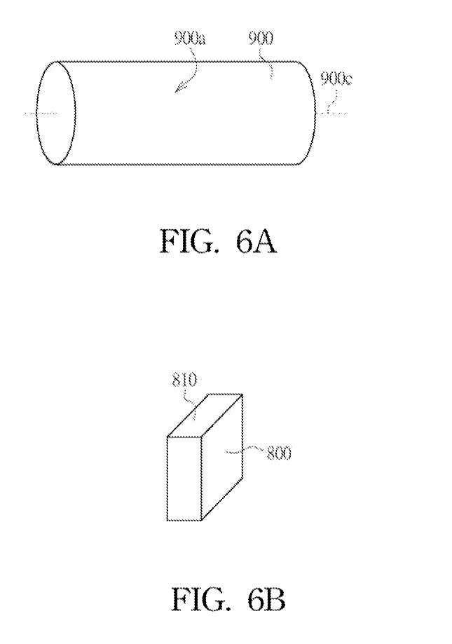

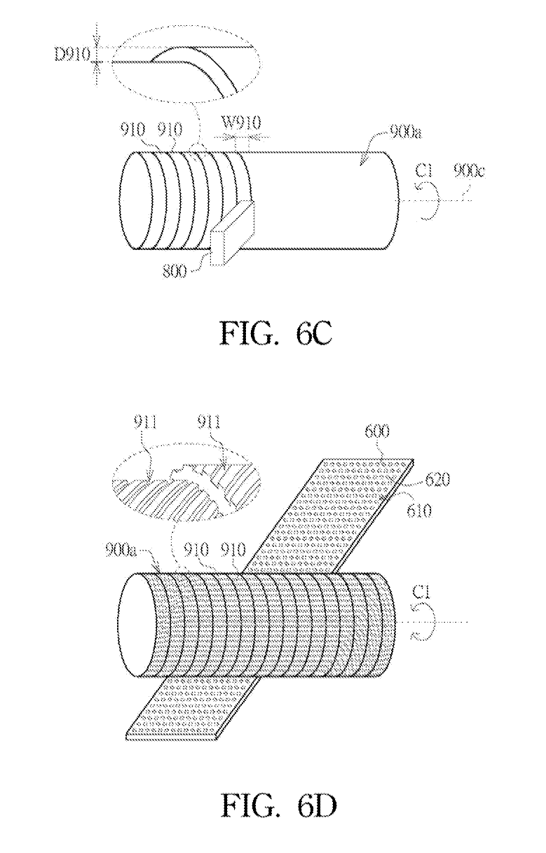

Referring to FIG. 5 and FIG. 6A to 6D, FIG. 5 is a flow chart of a manufacturing method of the roller 900 in step S303 above for the phase retardation film 100 of an embodiment of the present invention, and FIGS. 6A to 6D illustrate the steps of the manufacturing method of the roller 900 in FIG. 5. In step S501, as shown in FIG. 6A, the roller 900 is provided. The roller 900 has a rotating shaft 900c and a plane surface 900a.

In step S502, as shown in FIG. 6B, an engraving means 800 is provided, wherein the engraving means has a substantially plane engraving end 810;

In step S503, as shown in FIG. 6C, a grooved structure 910 with a depth D910 on the roller surface 900a is formed by engraving the roller surface 900a with the engraving means 800 along the rotating direction C1 of the roller with the depth D910. The roller 900 rotates in a shaft center to the rotating shaft 900c. The engraving means 800 contacts with the surface 900a of the roller 900 vertically and engraves the roller 900 along the surface 900a to form the grooved structure 910 thereon. Next, the engraving means 800 and the roller 900 separate each other, and then the engraving means 800 moves along the direction of the rotating shaft 900c oppositely to the roller 900 with a destined interval W910. Next, the engraving means 800 and the roller 900 are close to each other, and forming another grooved structure 910.

Next, in step S504, as shown in FIG. 6D, a rubbing pad 600 with a rubbing surface 600a is provided. An embodiment of the rubbing pad 600 includes for example a lubricant 610 and a plurality of SiO₂ particles 620.

Next, in step S505, as shown in FIG. 6D, the grooved surface 910 of the roller 900 is rubbed with the rubbing surface 600a of the rubbing pad 600 to form a submicro-scratch structure 911 thereon. The step S505 further comprises the steps of placing the rubbing pad 600 on the roller 900; rubbing the roller 900 with the rubbing pad 600 in a direction of 45° to the rotating direction C1 of the roller; and rotating the roller 900 back and forth until the whole surface 900a thereof with the submicro-scratch structure 911. Thereby the extending direction of the submicro-scratch structure 911 is in an angle of 45° to the rotating direction C1 of the roller 900.

An embodiment of the present invention is using the engraving means 800 to engrave the roller 900, and rubbing surface 900a of the roller 900 with the rubbing pad 600 to form the submicro-scratch structure 911. The roller 900 with the submicro-scratch structure 911 can emboss the base film 110 for manufacturing the phase retardation film 100 rapidly and precisely. Thus, the phase retardation film 100 with different phase retardations can apply for stereoscopic display technology.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for making a roller used in manufacturing a phase retardation film, comprising the steps of:
providing a roller including a rotating shaft and a surface;
providing an engraving means including an engraving end;
engraving a surface of the roller with the engraving means along a rotating direction of the roller with a depth to form a grooved structure on the surface of the roller;
providing a rubbing pad with a rubbing surface; and
rubbing the grooved surface of the roller with the rubbing surface of the rubbing pad to form a submicro-scratch structure thereon, wherein an extending direction of the submicro-scratch structure is in an angle of 45° to the rotating direction of the roller.

2. The method according to claim 1, wherein a surface of the engraving end of the engraving means is substantially plane.

3. The method according to claim 1, wherein the step of forming the submicro-scratch structure comprises the steps of:
placing the rubbing pad on the roller,
rubbing the roller with the rubbing pad in a direction of 45° to the rotating direction of the roller; and
rotating the roller back and forth until the whole surface thereof with the submicro-scratch structure.

4. The method according to claim 1, wherein said rubbing pad comprises a lubricant and a plurality of SiO₂ particles.

5. A method for manufacturing a phase retardation film, which includes a phase retardation layer with a plurality of first phase retardation regions and a plurality of second phase retardation regions, the phase difference between the first phase retardation regions and the second phase retardation regions being 180°, the method comprising the steps of:
providing a base film;
coating a curable resin layer on a surface of the base film;
embossing the curable resin layer with the roller made by the method as claimed in claim 1 to form a patterned resin layer with a plurality of first regions and a plurality of second regions, wherein the first regions and the second regions are grating stripe structures, and are parallel to and interleaved with each other, and to form a submicro-scratch structure for alignment on a top surface of the first regions and a bottom surface of the second regions at the same time, wherein the submicro-scratch structure includes a plurality of grooving stripes, and the angle between an extending direction of the grooving stripes of the submicro-scratch structure for alignment and an extending direction of the grating stripe structures of the first regions and the second regions is substantially 45°;
curing the patterned resin layer; and
disposing a liquid crystal material on the submicro-scratch structure of the patterned resin layer to form a phase retardation layer, wherein the liquid crystal material over the first regions provides the first phase retardation regions and the liquid crystal material over the second regions provides the second phase retardation regions.

6. The method according to claim 5, wherein the liquid crystal material is in direct contact with the patterned resin layer and is aligned with the submicro-scratch structure thereof.

7. A phase retardation film, comprising:
a base film;
a patterned resin layer with a plurality of first regions and a plurality of second regions on the base film, wherein the first regions and the second regions are grating stripe structures and parallel to each other, and the first regions relative to the second regions form a grating relief structure and interleaved with each other, the patterned resin layer comprising:
a submicro-scratch structure for alignment on a bottom surface of the first regions and a top surface of the second regions of the patterned resin layer, wherein the submicro-scratch structure includes a plurality of grooving stripes, and the angle between an extending direction of the grooving stripes of the submicro-scratch structure and an extending direction of the grating stripe structures of the first regions and the second regions is substantially 45°; and
a phase retardation layer formed by disposing a liquid crystal material on the submicro-scratch structure of the patterned resin layer, wherein the liquid crystal material over the first regions provides a first phase retardation and the liquid crystal material over the second regions provides a second phase retardation, and the phase difference between the first phase retardation and the second phase retardation is 180°.

8. The film according to claim 7, wherein a width of each of the first regions is equal to a width of each of the second regions.

9. The film according to claim 7, wherein the liquid crystal material is in direct contact with the patterned resin layer and is aligned with the submicro-scratch structure thereof.

10. The film according to claim 7, wherein the liquid crystal material includes a Vertical Alignment liquid crystal material.

11. The film according to claim 7, wherein the grooving stripes have a same width, and an interval between any two of the adjacent grooving stripes are substantially the same.
